(19) United States
(12) Patent Application Publication
(10) Pub. No.: US 2023/0167364 A1
(43) Pub. Date: Jun. 1, 2023

(54) METHOD FOR MANUFACTURING POLYMER DISPERSED LIQUID CRYSTAL DISPLAY ELEMENT, AND POLYMER DISPERSED LIQUID CRYSTAL DISPLAY ELEMENT

(71) Applicant: DIC Corporation, Tokyo (JP)

(72) Inventors: Hidetoshi NAKATA, Saitama (JP); Kazunori MARUYAMA, Saitama (JP)

(73) Assignee: DIC Corporation, Tokyo (JP)

(21) Appl. No.: 17/921,634

(22) PCT Filed: Apr. 22, 2021
(86) PCT No.: PCT/JP2021/016234

§ 371 Date: Oct. 27, 2022

(30) Foreign Application Priority Data
May 13, 2020 (JP) 2020-084331

(51) Int. Cl. C09K 19/54; C09K 19/30; C09K 19/34; G02F 1/1334

(52) U.S. Cl. CPC C09K 19/544; C09K 19/3068; C09K 19/3469; G02F 1/13347; C09K 2019/3083

(57) ABSTRACT

The present invention is to find appropriate manufacturing conditions for obtaining a homogeneous scattering state, a homogeneous transparent state, and a homogeneous driving voltage state and to obtain a polymer dispersed liquid crystal display element that has homogeneous properties. A polymer dispersed liquid crystal display element having excellent homogeneity can be obtained by irradiating a light control layer-forming material containing a liquid crystal material and a polymerizable composition with ultraviolet light under specific ultraviolet irradiation conditions to polymerize the polymerizable composition.

### TECHNICAL FIELD

The present invention relates to a method for manufacturing a polymer dispersed liquid crystal display element that has a light control layer composed of a liquid crystal material and a polymer substance obtained by polymerizing a polymerizable composition, and to the polymer dispersed liquid crystal display element. Examples of the polymer dispersed liquid crystal display element include a light shutter used for light control of digital cameras and smart phones, a light scattering plate of a display light source, a light guiding plate, a reflector plate of a reflective display or a transparent display, and an article including a light control element etc., and examples of the light control element include a light control element, such as glass windows, doors, partitions, and private glass, used in architectural structures such as houses and buildings, a light control element used in as glass windows, mirrors, and roofs used in transportation media such as automobiles, airplanes, ships, and trains, and decorative light control elements such as sunglasses, glasses, sun visors, clocks, mirrors, and reflector plates.

### BACKGROUND ART

A polymer dispersed liquid crystal display element manufactured by using a polymer dispersed liquid crystal composition does not require a polarizing plate; thus, there is an advantage over existing TN, STN, IPS, and VA mode liquid crystal display elements that use conventional polarizing plates in that brighter display is possible with a simple element structure, and thus the polymer dispersed liquid crystal display element has been applied to light shutter usages such as light control glass, various optical element usages, and segment display usages such as clocks. A polymer dispersed liquid crystal display element involves a mode of controlling light scattering and transmitting by using a polymer to switch from a state in which liquid crystal molecules are out of alignment to a state in which voltage is applied to align the liquid crystal compound in one direction. The element is milky when scattering and is transparent when transmitting.

There are several types of polymer dispersed liquid crystal display elements, and, for example, a type (PTL 1) known as NCAP in which droplets of a liquid crystal substance are dispersed in a polymer is suitable for increasing the area, but requires high driving voltage. To address this issue, for example, a type (PTL 2) known as PDLC or PNLC that utilizes polymer phase separation induced by irradiating a mixture of a liquid crystal material and a polymerizable monomer with ultraviolet light has been proposed. In particular, PNLC in which a polymer network structure is formed in a liquid crystal continuous phase has been applied to optical devices, display elements, etc., that require lower voltage. According to the PNLC, by controlling not only the physical properties of a liquid crystal composition used and a monomer composition which is a polymer-forming material, but also the size of the polymer network structure and other properties, a polymer dispersed liquid crystal display element that has intended physical property values can be manufactured.

These types of polymer dispersed liquid crystal elements that are manufactured by ultraviolet irradiation have issues in that homogeneous transmitting/scattering state, driving voltage, and halftone state are unlikely to be achieved unless the manufacturing steps therefor are appropriately controlled, and thus have faced issues such as low yield in mass production. Although PTL 3 investigates suppressing the ultraviolet irradiation intensity distribution to within a particular distribution, this alone does not fully address these issues.

### CITATION LIST

### Patent Literature

PTL 1: Japanese Unexamined Patent Application Publication No. 8-286162
PTL 2: U.S. Pat. No. 5,304,323
PTL 3: Japanese Unexamined Patent Application Publication No. 5-066387

### SUMMARY OF INVENTION

### Technical Problem

An object of the present invention is to find appropriate manufacturing conditions for obtaining a homogeneous scattering state, a homogeneous transparent state, and a homogeneous driving voltage state in a polymer dispersed liquid crystal element manufacturing method and to obtain a polymer dispersed liquid crystal element that has homogeneous properties.

### Solution to Problem

The inventors of the present invention have conducted extensive studies to address the aforementioned issues. As a result, the inventors have found that a polymer dispersed liquid crystal display element having excellent homogeneity can be manufactured under specific manufacturing conditions and thus completed the present invention.

That is, the present invention provides a polymer dispersed liquid crystal display element manufacturing method and a polymer dispersed liquid crystal display element that have following features: in a method for manufacturing a polymer dispersed liquid crystal display element that has a light control layer that contains a liquid crystal material and a polymer substance and that is obtained by interposing a light control layer-forming material containing a liquid crystal material and a polymerizable composition between two substrates at least one of which has an electrode layer and at least one of which is transparent, and then irradiating the light control layer-forming material with ultraviolet light to polymerize the polymerizable composition, in a transmittance distribution of the light control layer, a ratio ((A−B)/B×100) of a difference (A−B) between an average value A of the top 10% and an average value B of the bottom 10% to the average value B of the bottom 10% is 200% or less, and, a minimum ultraviolet reflectance of an installation surface of the liquid crystal display element is 50% or more of a maximum ultraviolet reflectance, the installation surface being located on a side opposite of an ultraviolet irradiation lamp as viewed from the liquid crystal display element to be irradiated with the ultraviolet light.

### Advantageous Effects of Invention

According to the manufacturing method of the present invention, a polymer dispersed liquid crystal display element that is homogeneous in terms of a scattering state, a transparent state, and driving voltage is obtained.

### BRIEF DESCRIPTION OF DRAWINGS

FIG. 1 is a schematic diagram of a rear surface plate used to manufacture a polymer dispersed liquid crystal display element of the invention of the present application by UV irradiation.

FIG. 2 is a schematic diagram of grids of measurement points for measuring physical properties of the polymer dispersed liquid crystal display element of the invention of the present application.

### DESCRIPTION OF EMBODIMENTS

A polymer dispersed liquid crystal display element obtained by the manufacturing method of the present invention can be obtained by placing a polymer dispersed liquid crystal composition composed of a liquid crystal composition (liquid crystal material), a polymerizable composition, and a polymerization initiator between two substrates, such as ITO-coated glass substrates, at least one of which has an electrode layer and at least one of which is transparent, by injection or the like, and irradiating the light control layer with ultraviolet light so as to induce phase separation between a liquid crystal phase and a polymer phase and polymerize the polymerizable monomer composition to thereby form a polymer network structure in the liquid crystal phase or form liquid crystal droplet structures in the polymer. It is critical for obtaining homogeneous properties to control the ultraviolet curing process and the steps leading up to the ultraviolet curing process. In addition, the influence of controlling the manufacturing steps greatly changes depending on the liquid crystal composition used.

The homogeneity of the properties can be evaluated by the transmittance within the surface of a polymer dispersed liquid crystal display element. That is, the index of homogeneous properties is, for example, the ratio ((A−B)/B×100) of the difference (A−B) between the average value A of the top 10% transmittances and an average value B of the bottom 10% transmittances to the average value B of the bottom 10% transmittances, and this value is preferably 200% or less, more preferably 100% or less, yet more preferably 50% or less, and most preferably 30% or less.

The transmittance of the present invention is the value measured with an LCD evaluator LCD-5200 produced by OTSUKA ELECTRONICS CO., LTD., with B lens and aperture S, and is equivalent to the condition of 3.2° converging angle.

A method for manufacturing a polymer dispersed liquid crystal display element of the present invention will now be described. A polymer dispersed liquid crystal display element that has homogeneous properties mentioned above can be manufactured by the following method. After a light control layer-forming material that contains a liquid crystal material and a polymerizable composition is interposed between two substrates at least one of which has an electrode layer and at least one of which is transparent, heat or an active energy ray is applied to polymerize the polymerizable composition and induce phase separation with the liquid crystal composition so that a light control layer composed of a liquid crystal composition and a transparent polymer substance is formed. A polymer dispersed liquid crystal display element can be thereby obtained. In particular, a technique of inducing phase separation with the liquid crystal composition by polymerizing the polymerizable compound by ultraviolet irradiation is preferable.

The two substrates can be composed of a flexible transparent material such as glass or plastics, and one of the substrates may be composed of an opaque material such as silicon. A transparent substrate that has a transparent electrode layer can be obtained by, for example, sputter-depositing indium tin oxide (ITO) on a transparent substrate such as a glass plate. Furthermore, the use of a low-wavelength-dispersive transparent substrate is preferable since the light scattering ability of the device of the present invention is increased, and the reflectance and contrast are improved. Examples of the low-wavelength-dispersive transparent substrate include borosilicate glass, plastic transparent films such as polyethylene terephthalate or polycarbonate, and a transparent substrate coated with a dielectric multilayer film that uses the ¼λ optical interference conditions.

If needed, a polymer film, an alignment film, a SiO₂ film, a SiNx film, and/or a color filter may be disposed on the substrates. A polyimide alignment film, an optical alignment film, or the like can be used as the alignment film. The alignment film is formed by, for example, if a polyimide alignment film is to be formed, applying a polyimide resin composition to the transparent substrate and thermally curing the applied composition at a temperature of 180° C. or higher. In general, for polymer dispersed liquid crystal display elements, the rubbing process that uses cotton cloth, rayon cloth, or the like is not performed.

The color filter can be prepared by, for example, a pigment dispersing method, a printing method, an electrodeposition method, or a staining method. A method for preparing a color filter by a pigment dispersing method is described as an example. That is, a curable coloring composition for a color filter is applied to the transparent substrate, subjected to patterning, and cured by applying heat or light. This process is performed for each of three colors, red, green, and blue, and pixel portions for a color filter can be prepared as a result. Additionally, pixel electrodes equipped with active elements, such as a TFT, a thin film diode, or a metal-insulator-metal specific resistance element, may be disposed on the substrate.

The substrates are arranged to face each other with the transparent electrode layers on the inner side. Here, the space between the substrates may be adjusted by using a spacer. Here, the adjustment is preferably made such that the thickness of the light control layer to be obtained is 1 to 100 μm. In particular, 2 to 50 μm is preferable, 2 to 30 μm is more preferable, 5 to 25 μm is yet more preferable, and 5 to 15 μm is most preferable. Examples of the spacer include glass particles, plastic particles, alumina particles, and photoresist materials. Subsequently, a sealing agent such as an epoxy thermosetting composition is screen-printed on the substrates, the substrates are bonded together, and the sealing agent is cured by heating or ultraviolet irradiation.

The method for interposing the light control layer-forming material between two substrates may be a common vacuum injection method; alternatively, a dropping or applying method such as an ODF method or an ink jet method is also preferable. During the period from vacuum injection or the dropping or applying step to ultraviolet irradiation for forming a network structure in the light control layer, the light control layer-forming material is preferably in a homogeneous isotropic state. This homogeneous isotropic state can be obtained at a temperature equal to or higher than the nematic-isotropic transition point (Tni(PNM)) of the polymer dispersed liquid crystal composition. In other words, during the time from injection or the like to ultraviolet irradiation, the polymer dispersed liquid crystal composition is preferably maintained at a temperature equal to or higher than Tni(PNM). At a temperature equal to or lower than Tni(PNM), the composition is separated into two phases, a liquid crystal composition-rich phase and a polymerizable composition-rich phase, and the homogeneous state may not be obtained. A homogeneous state is difficult to obtain if injection or the like is carried out in such a state. In particular, when two-phase separation occurs by adjusting the temperature to Tni(PNM) or lower after the composition is interposed between the two substrates, it is difficult to homogeneously mix two phases even when the temperature is subsequently adjusted to Tni(PNM) or higher. As a result, it becomes difficult to obtain a polymer dispersed liquid crystal display element that has homogeneous properties.

Examples of the lamp used for ultraviolet polymerization include a metal halide lamp, a high-pressure mercury lamp, and a super-high-pressure mercury lamp. The wavelength of the ultraviolet light for irradiation is preferably in a wavelength region within the absorption wavelength region of the photoinitiator contained in the light control layer-forming material but outside the absorption wavelength region of the liquid crystal composition contained. Specifically, a metal halide lamp, a high-pressure mercury lamp, and a super-high-pressure mercury lamp is preferably used by cutting off the ultraviolet light of 330 nm or less. Alternatively, use of an UV-LED lamp that can emit a single wavelength is also preferable.

More specifically, the intensity of 313 nm ultraviolet light is preferably 10% or less, more preferably 5% or less, and yet more preferably 1% or less of the intensity of 365 nm ultraviolet light. The 313 nm light causes degradation of the liquid crystal compound and adversely affects the polymerization process since it overlaps the absorption wavelength of some liquid crystal compounds. In particular, these phenomena arise prominently when the liquid crystal composition contains a compound represented by general formula (II) below.

The temperature during ultraviolet irradiation is a critical factor that determines the properties of the light control layer. As mentioned above, the polymer dispersed liquid crystal composition preferably has a temperature equal to or higher than Ti(PNM), more preferably has a temperature 0.1° C. to 15.0° C. higher than Ti(PNM), yet more preferably has a temperature 0.2° C. to 10.0° C. higher than Ti(PNM), and most preferably has a temperature 0.3° C. to 5.0° C. hither than Ti(PNM).

Furthermore the state of the surface on the opposite side of the ultraviolet lamp during ultraviolet irradiation as viewed from the liquid crystal display element in which the polymer dispersed liquid crystal composition is interposed between the glass substrates or the like, in other words, the state of the rear surface of the liquid crystal display element, is also a critical factor for obtaining a polymer dispersed liquid crystal display element that has homogeneous properties. During the process of ultraviolet irradiation, not only the direct light from the ultraviolet lamp but also reflected light after the light has passed through the liquid crystal display element affects the homogeneity of the properties. This influence is particularly prominent when the liquid crystal composition contains a compound represented by general formula (I-1) below.

The minimum ultraviolet reflectance at the surface on the opposite side of the ultraviolet lamp as viewed from the liquid crystal display element is preferably 40% or more, more preferably 50% or more, yet more preferably 70% or more, and most preferably 80% or more of the maximum ultraviolet reflectance. In particular, cautions are necessary when a guide line for positioning or the like is to be formed on the rear surface or when a vacuum chuck for fixing a display element is to be disposed on the rear surface. With such specifications, traces such as vacuum chuck marks remain on the display element and homogeneous display is not obtained unless the influence of the reflection during ultraviolet irradiation is considered. Here, the ultraviolet reflectance is evaluated in terms of the reflectance at 365 nm using a reflection measuring function of a spectrophotometer.

The light control layer of the polymer dispersed liquid crystal display element prepared by the aforementioned technique has a droplet structure in which the liquid crystal composition is enclosed in capsules by a polymer substance, a structure in which three-dimensional network structure of a polymer substance is formed in a continuous phase of the liquid crystal composition, or a structure in which both of these structures are mixed; however, a structure in which a three-dimensional network structure of a transparent polymer substance is formed in a continuous phase of the liquid crystal composition is preferable.

The average gap intervals of the network structure notably affects the properties of the polymer dispersed liquid crystal display element, and is preferably 0.2 to 2 μm, more preferably 0.4 to 1.5 μm, and most preferably 0.5 to 1.0 μm.

### (Liquid Crystal Composition)

The liquid crystal composition used in the polymer dispersed liquid crystal composition of the present invention preferably contains a compound represented by general formula (I) and more preferably contains two or more compounds represented by general formula (I).

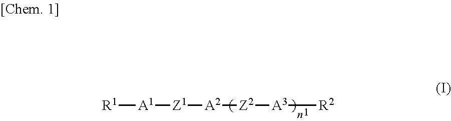

(In the formula, R¹ represents an alkyl group having 1 to 10 carbon atoms, one or two nonadjacent CH₂ groups in the alkyl group may each be substituted with an oxygen atom, —COO—, or —OCO—, and at least one methylene group may be substituted with —CH═CH— or —CH≡CH—.

R² represents a fluorine atom, a chlorine atom, a cyano group, a CF₃ group, an OCF₃ group, an OCHF₂ group, a NCS group, or an alkyl group having 1 to 10 carbon atoms, one or two nonadjacent CH₂ groups in the alkyl group may each be substituted with an oxygen atom, —COO—, or —OCO—, at least one methylene group may be substituted with —CH═CH— or —C≡C—, and R² preferably represents a fluorine atom, a cyano group, or an alkyl group having 1 to 5 carbon atoms (one or two nonadjacent CH₂ groups in the alkyl group may each be substituted with an oxygen atom, and at least one methylene group may be substituted with —CH═CH— or —CH≡CH—). Z¹ and Z² each independently represent a single bond, —COO—, —OCO—, —CH₂—CH₂—, —CH═CH—, —CF₂O—, —OCF₂—, or —C≡C—, and when more than one Z¹ are present, they may be the same or different.

A¹, A², and A³ each independently represent a 1,4-phenylene group, a 1,4-cyclohexylene group, a 1,4-cyclohexenyl group, a tetrahydropyran-2,5-diyl group, a 1,3-dioxane-2,5-diyl group, a decahydronaphthalene-2,6-diyl group, a pyridine-2,5-diyl group, a pyrimidine-2,5-diyl group, a pyrazine-2,5-diyl group, a 1,2,3,4-tetrahydronaphthalene-2,6-diyl group, or a 2,6-naphthylene group, the 1,4-phenylene group, the 1,2,3,4-tetrahydrohaphthalene-2,6-diyl group, and the 2,6-naphthylene group may each be unsubstituted or have, as a substituent, one or more fluorine atoms, chlorine atoms, CF₃ groups, OCF₃ groups, or CH₃ groups, and when more than one A³ are present, they may be the same or different.
n¹ represents 0, 1, or 2.)

Among compounds represented by general formula (I), one or more compound represented by general formula (I-1) are preferably contained:

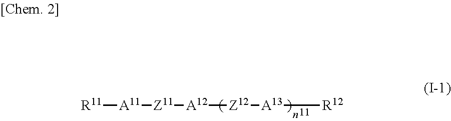

(In formula, R¹¹ represents an alkyl group having 1 to 10 carbon atoms, one or two nonadjacent CH₂ groups in the alkyl group may each be substituted with an oxygen atom, —COO—, or —OCO—, and at least one methylene group may be substituted with —CH═CH— or —CH≡CH—.

R¹² represents a fluorine atom, a chlorine atom, a cyano group, a CF₃ group, an OCF₃ group, an OCHF₂ group, a NCS group, or an alkyl group having 1 to 10 carbon atoms, one or two nonadjacent CH₂ groups in the alkyl group may each be substituted with an oxygen atom, —COO—, or —OCO—, at least one methylene group may be substituted with —CH═CH— or —C≡C—, and R¹² preferably represents a fluorine atom, a cyano group, or an alkyl group having 1 to 5 carbon atoms (one or two nonadjacent CH₂ groups in the alkyl group may each be substituted with an oxygen atom).

Z¹¹ and Z¹² each independently represent a single bond, —COO—, —OCO—, —CH₂—CH₂—, —CH═CH—, —CF₂O—, —OCF₂—, or —C≡C—, and when more than one Z¹² are present, they may be the same or different.

A¹¹, A¹², and A¹³ each independently represent a 1,4-phenylene group, a 1,4-cyclohexylene group, a 1,4-cyclohexenyl group, a tetrahydropyran-2,5-diyl group, a 1,3-dioxane-2,5-diyl group, a decahydronaphthalene-2,6-diyl group, a pyridine-2,5-diyl group, a pyrimidine-2,5-diyl group, a pyrazine-2,5-diyl group, a 1,2,3,4-tetrahydronaphthalene-2,6-diyl group, or a 2,6-naphthylene group, the 1,4-phenylene group, the 1,2,3,4-tetrahydrohaphthalene-2,6-diyl group, and the 2,6-naphthylene group may each be unsubstituted or have, as a substituent, one or more fluorine atoms, chlorine atoms, CF₃ groups, OCF₃ groups, or CH₃ groups, and when more than one A¹³ are present, they may be the same or different.
n₁₁ represents 0, 1, or 2.
At least one methylene group in R¹¹ is substituted with —CH═CH— or —C≡C—, at least one methylene group in R¹¹ is substituted with —CH═CH— or —C≡C—, Z¹¹ represents —CH═CH— or —C≡C—, and/or Z¹² when present is —CH═CH— or —C≡C—.) More preferably, two or more such compounds are contained.

Containing a compound represented by general formula (I-1) can further decrease the driving voltage and improve scattering properties. The presence of double bonds or triple bonds in these compounds affects the polymerization process of the polymerizable composition during ultraviolet irradiation and offers effects such as slowing the polymerization rate; thus, it becomes easier to control the polymer network structure or the polymer droplet structure.

This also means that the process is highly affected by various conditions in the ultraviolet polymerization step described above. A compound represented by general formula (I-1) and a compound represented by general formula (I) but not by general formula (I-1) are both preferably contained, and, more preferably, two or more compounds represented by general formula (I-1) and two or more of compounds represented by general formula (I) but not general formula (I-1) are contained.

For a compound represented by general formula (I) but not by general formula (I-1), R¹ in general formula (I) preferably represents an alkyl group having 1 to 5 carbon atoms (one or two nonadjacent CH₂ groups in the alkyl group may each be substituted with an oxygen atom); R² preferably represents a fluorine atom, a cyano group, or an alkyl group having 1 to 5 carbon atoms (one or two nonadjacent CH₂ groups in the alkyl group may each be substituted with an oxygen atom); Z¹ and Z² preferably each independently represent a single bond, —COO—, —OCO—, —CH₂—CH₂—, —CF₂O—, or —OCF₂— (when more than one Z¹ are present, they may be the same or different) and more preferably each independently represent a single bond, —COO—, or —CF₂O—; A¹, A², and A³ preferably each independently represent a 1,4-phenylene group, a 1,4-cyclohexylene group, a 1,3-dioxane-2,5-diyl group, a pyrimidine-2,5-diyl group, a 1,2,3,4-tetrahydronaphthalene-2,6-diyl group, or a 2,6-naphthylene group (the 1,4-phenylene group, the 1,2,3,4-tetrahydrohaphthalene-2,6-diyl group, and the 2,6-naphthylene group may each be unsubstituted or have, as a substituent, one or more fluorine atoms or CH₃ groups, and when more than one A³ are present, they may be the same or different), and more preferably each independently represent a 1,4-phenylene group, a 1,4-cyclohexylene group, a pyrimidine-2,5-diyl group, or a 2,6-naphthylene group (the 1,4-phenylene group and the 2,6-naphthalene group may each be unsubstituted or have, as a substituent one or more fluorine atoms or a CH₃ group, and when more than one A³ are present, they may be the same or different); and n¹ is preferably 0 or 1.

For a compound represented by general formula (I-1), preferable is a compound where R¹¹ represents an alkenyl group having 1 to 5 carbon atoms, R¹² represents a fluorine atom or an alkyl group having 1 to 5 carbon atoms (one or two nonadjacent CH₂ groups in the alkyl group may each be substituted with an oxygen atom), Z¹¹ and Z¹² each independently represent a single bond, —COO—, or —CF₂O— (where more than one Z¹² are present, they may be the same or different), A¹¹, A¹², and A¹³ each independently represent a 1,4-phenylene group, a 1,4-cyclohexylene group (the 1,4-phenylene group may be unsubstituted or have, as a substituent, one or more fluorine atoms or CH₃ groups, and when more than one A¹³ are present they may be the same or different), and n¹¹ represents 0 or 1, or a compound where R¹¹ and R¹² each independently represent an alkyl group having 1 to 5 carbon atoms (one or two nonadjacent CH₂ groups in the alkyl group may each be substituted with an oxygen atom, and at least one methylene group may be substituted with —CH═CH—), Z¹¹ and Z¹² each independently represent a single bond, —COO—, —CF₂O—, or —C≡C— (when more than one Z¹² are present, they may be the same or different, but at least one of Z¹¹ and Z¹² represents —C≡C—), A¹¹, A¹², and A¹³ each independently represent a 1,4-phenylene group, a 1,4-cyclohexylene group (the 1,4-phenylene group may be unsubstituted or have, as a substituent, one or more fluorine atoms or CH₃ groups, and when more than one A¹³ are present, they may be the same or different), and n¹¹ represents 0 or 1.

Specifically, compounds represented by formulae (II-1) to (II-54) below are preferable.

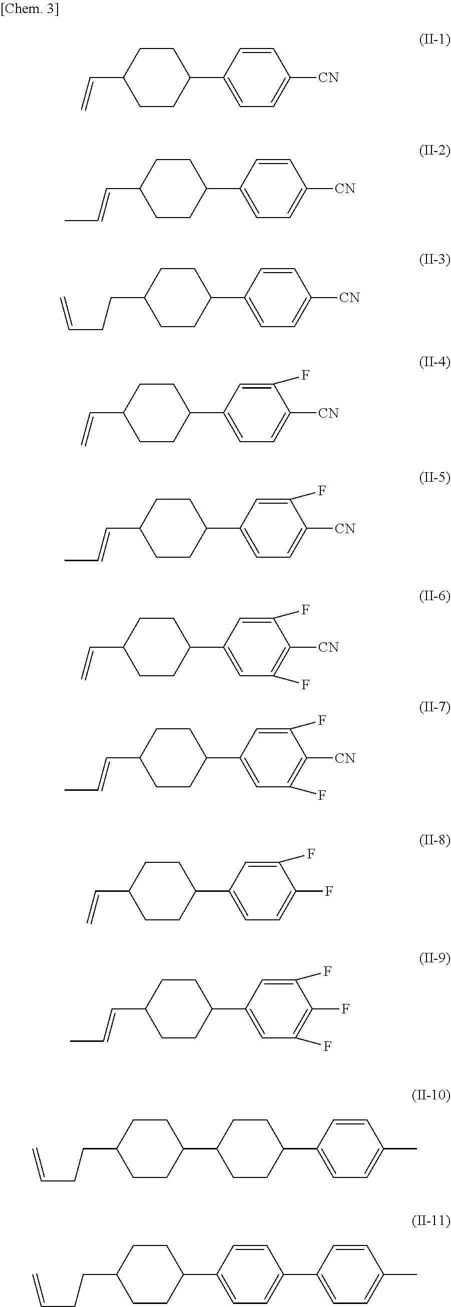

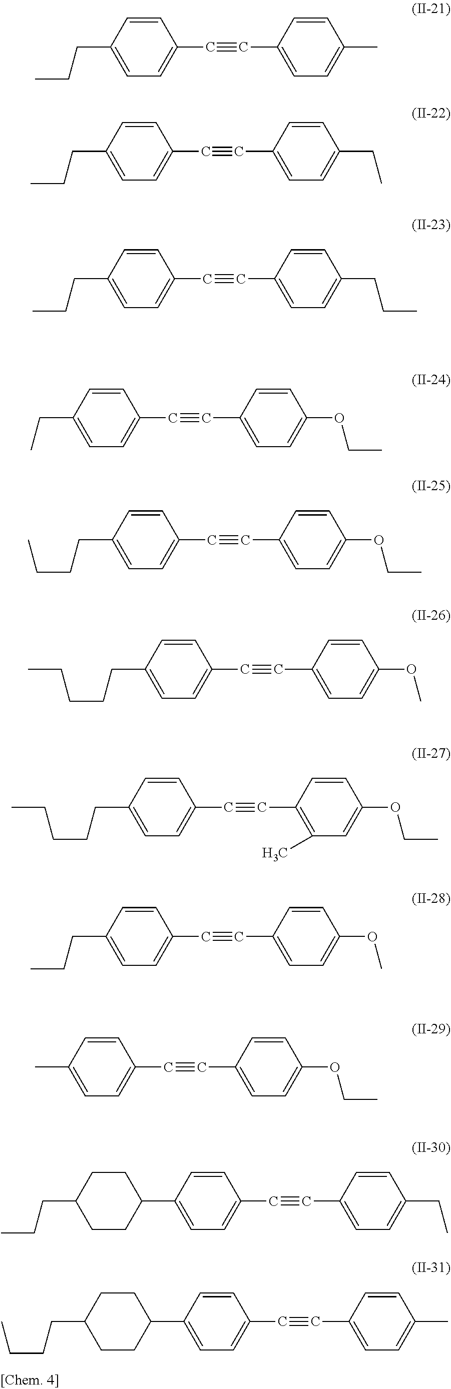

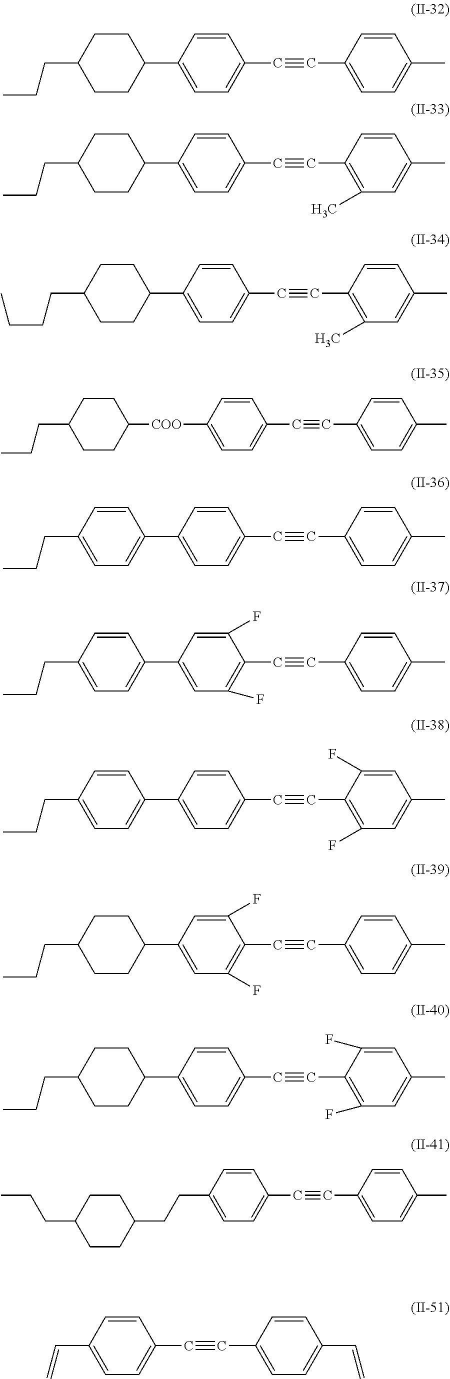

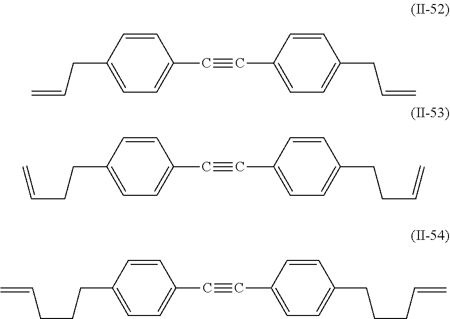

### (Polymerizable Composition)

The polymer substance forming the network structure or the like in the light control layer is obtained by polymerizing a polymerizable composition (polymerizable monomer composition) in the polymer dispersed liquid crystal composition. The polymerizable composition is preferably composed of a compound that cures under heat or ultraviolet light, and is preferably composed of an ultraviolet-curable polymerizable compound. Examples of the ultraviolet-curable polymerizable compound include radial polymerizable, cation polymerizable, and anion polymerizable compounds. A radical polymerizable compound is preferable, and, in particular, an acrylic or methacrylic polymerizable compound is more preferable. Examples of the acrylic or methacrylic polymerizable compound include monofunctional polymerizable compounds and polyfunctional polymerizable compounds. Preferably, at least one polyfunctional polymerizable compound is contained, and more preferably at least one difunctional polymerizable compound is contained. More preferable is a combination of a difunctional polymerizable compound and a monofunctional polymerizable compound.

The difunctional polymerizable compound is not particularly limited but is preferably a compound represented by general formula (III-1):

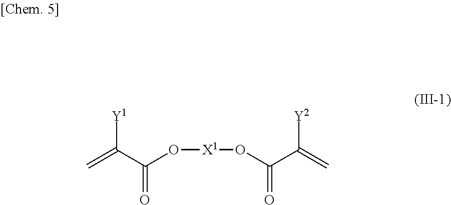

(In the formula, Y¹ and Y² each represent a hydrogen atom or a methyl group and X¹ represents a divalent organic group.) X¹ representing the divalent organic group preferably has a molecular weight of 150 to 15000 and more preferably 350 to 10000, and is preferably a group constituted by carbon, oxygen, nitrogen, and hydrogen atoms.
If adhesiveness is most important, X¹ is preferably represented by general formula (III-2):

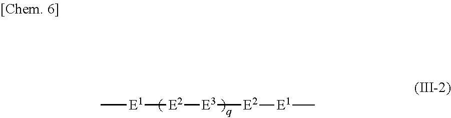

(In the formula, E¹ represents an alkyl group having 1 to 4 carbon atoms, one or more —CH₂— in the alkyl group may each be substituted with an oxygen atom, —CO—, —COO—, or —OCO—, q represents 1 to 20, E² represents one of (III-2-1) to (III-2-4) below:

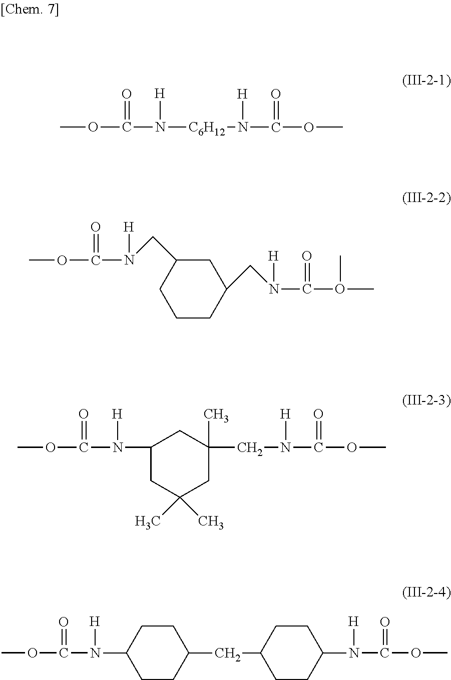

and E³ represents (III-3-1) or (III-3-2) below:

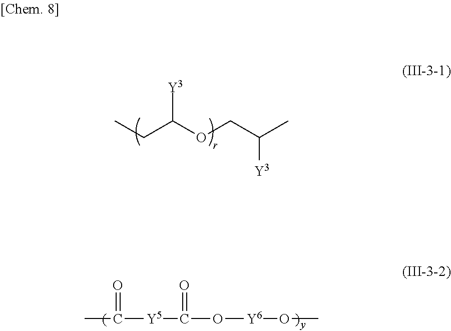

(In the formulae, Y³ represents a hydrogen atom or a methyl group, Y⁵ represents a divalent aromatic group, a divalent alicyclic hydrocarbon group, or an alkylene group having 1 to 14 carbon atoms, the alkylene may be substituted with an oxygen atom or a —CO— group, Y⁶ represents an alkylene group having 1 to 14 carbon atoms, the alkylene may be substituted with an oxygen atom or a —CO— group, and r and y each represent 10 to 300.) If driving voltage is important, X¹ is preferably represented by one of general formulae (III-4-1) to (III-4-3):

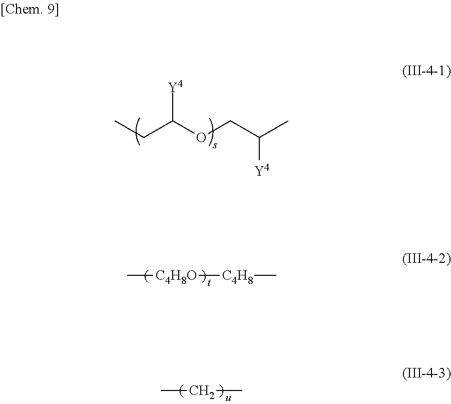

(In the formulae, Y⁴ each independently represent a hydrogen atom or a methyl group, s and t each represent an integer of 2 to 15, u represents an integer of 6 to 40, one or more CH₂ groups in formula (III-4-3) may each be substituted with an oxygen atom, —CO—, —NH—, —COO—, or —OCO— provided that the oxygen atoms do not directly bond to each other, and one or two hydrogen atoms in the CH₂ group may each be substituted with a methyl group or an ethyl group.)

A compound with X¹ representing (III-5-1) or (III-5-2) below is more preferable.

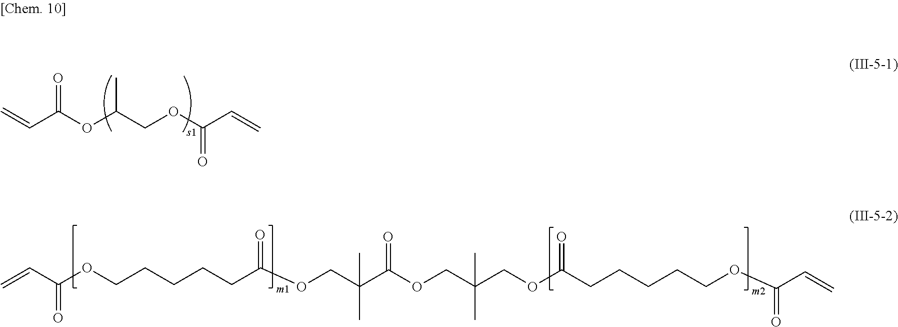

(In the formula, s1 represents an integer of 3 to 12, and m1+m2 is an integer of 0 to 6.)

The monofunctional compound is also not particularly limited but is preferably a compound represented by general formula (IV-1):

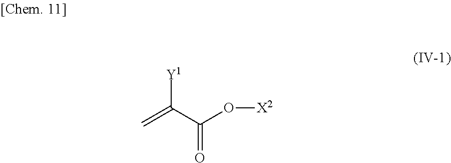

(In the formula, Y¹ represents a hydrogen atom or a methyl group and X² represents a monovalent organic group.)

X² representing the monovalent organic group preferably has a molecular weight of 100 to 1000, more preferably 110 to 500, and yet more preferably 120 to 300, and is preferably a group constituted by carbon, oxygen, and hydrogen atoms and is more preferably free of benzene rings. X² is more preferably an alkyl group that has 8 to 30 carbon atoms and may have a branched group or a cyclic group (one or two or more nonadjacent —CH₂— in the alkyl group may each independently be substituted by an oxygen atom, —COO—, or —OCO—), is more preferably an alkyl group that has 10 to 25 carbon atoms and may have a branched group (one or two or more nonadjacent —CH₂— in the alkyl group may each independently be substituted with an oxygen atom, —COO—, or —OCO—), and is yet more preferably an alkyl group that has 16 to 24 carbon atoms and has a branched group.

In forming a polymer substance constituting the network structure in the light control layer by ultraviolet polymerization, a photoinitiator is preferably used. The photoinitiator is not particularly limited but is preferably an intramolecular cleavage-type initiators such as an alkylphenone, acylphosphine oxide, or oxime ester initiator. Preferable specific examples thereof include diphenyl-(2,4,6-trimethylbenzoyl)phosphine oxide, 2,2-dimethoxy-1,2-diphenylethan-1-one, 1-hydroxy-cyclohexyl-phenyl-ketone, 2-hydroxy-2-methyl-1-phenyl-propan-1-one, benzophenone, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]-phenyl}-2-methyl-propan-1-one, phenylglyoxylic acid methyl ester, 2-methyl-1-[4-(methylthio)phenyl]-2-morpholinopropan-1-one, 2-benzyl-2-dimethylamino-1-(4-morpholinophenyl)-butanone-1,2-dimethylamino-2-(4-methyl-benzyl)-1-(4-morpholin-4-yl-phenyl)-butan-1-one, bis(2,4,6-trimethylbenzoyl)-phenylphosphine oxide, bis(2,4,6-trimethylbenzoyl)-phenylphosphine oxide, 1,2-octanedione, 1-[4-(phenylthio)-,2-(O-benzoyloxime)], ethanone, 1-[9-ethyl-6-(2-methylbenzoyl)-9H-carbazol-3-yl]-,1-(0-acetyloxime), benzophenone, methylbenzoyl formate, oligo{2-hydroxy-2-methyl-1-[4-(1-methylvinyl)phenyl]propanone, 2,4,6-trimethylbenzophenone, 4-methylbenzophenone, 2-ethoxy-1,2-diphenylethan-1-one, 2-(1-methylethoxy)-1,2-diphenylethan-1-one, and 2-isobutoxy-2-phenylacetophenone.

Among these, 2,2-dimethoxy-1,2-diphenylethan-1-one, 1-hydroxy-cyclohexyl-phenyl-ketone, and 2-hydroxy-2-methyl-1-phenyl-propan-1-one are particularly preferable.

The polymer dispersed liquid crystal composition used in the polymer dispersed liquid crystal element of the present invention is composed of the aforementioned liquid crystal composition (liquid crystal material), the polymerizable composition, and the polymerization initiator, and the ratio (mass ratio) of the liquid crystal composition to the polymerizable composition is preferably in the range of 90:10 to 40:60, more preferably in the range of 85:15 to 60:40, and yet more preferably in the range of 80:20 to 70:30.

The amount of the polymerization initiator added in the polymer dispersed liquid crystal composition is preferably 0.001 to 3 mass %, more preferably 0.01 to 2 mass %, and yet more preferably 0.1 to 1 mass %.

In addition to the aforementioned compounds, additives and the like can be contained as appropriate to the polymer dispersed liquid crystal composition used in the polymer dispersed liquid crystal element of the present invention. Examples of the additives include a polymerization inhibitor, an antioxidant, a photostabilizer such as HALS, a pigment, a dichroism pigment, and a fluorescent pigment.

### EXAMPLES

The present invention will now be described in further detail through examples below which do not limit the present invention. In examples and comparative examples below, “%” for the composition means “mass %”.

Polymer dispersed liquid crystal display elements of Examples were prepared by the following method.

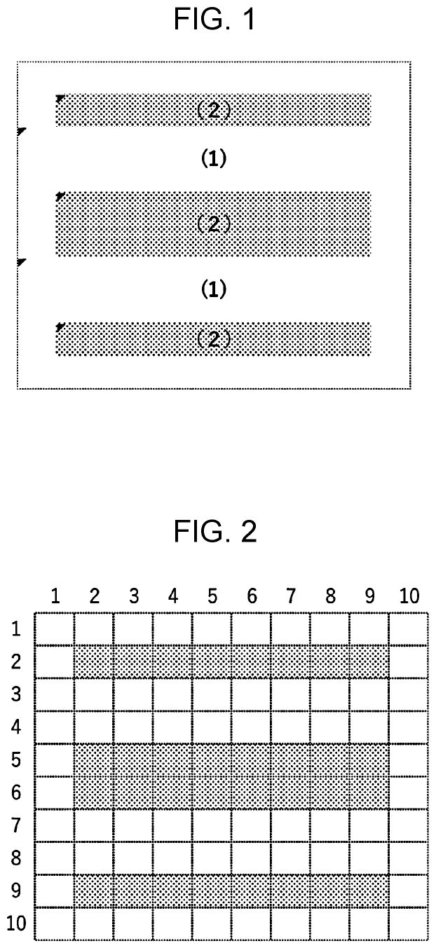

A polymer dispersed liquid crystal composition containing 78 mass % of a liquid crystal composition, 21.6 mass % of a polymerizable monomer composition, and 0.4 mass % of a photoinitiator was injected into an ITO-attached glass cell having a cell thickness of 10 μm while the composition was in an isotropic state and was maintained at a temperature higher than the isotropic-nematic transition point of the polymer dispersed liquid crystal composition. The injection port was sealed with a sealant 3026E (produced by ThreeBond Co., Ltd.), the temperature was controlled to a predetermined temperature, and light from a metal halide lamp adjusted to an irradiation intensity of 20 mW/cm² was applied, through an UV-cut filter if necessary, for 60 seconds to obtain a polymer dispersed liquid crystal display element. During UV irradiation, a rear plate illustrated in FIG. 1 was installed on the rear surface.

A soda lime glass having a thickness indicated in Table 1 was used as appropriate as the UV-cut filter.

TABLE 1

| Filter conditions | F1 | F2 | F3 |
|---|---|---|---|
| Glass thickness | 5 mm | 1.1 mm | No glass |
| Intensity at 313 nm | 0.5% | 12% | 50% |
| assuming intensity | | | |
| at 365 nm as 100% | | | |

After the composition in an isotropic state was injected into the glass cell, the cell was left under the conditions indicated in Table 2 for 1 minute and then irradiated with ultraviolet light.

TABLE 2

| Temperature conditions | T1 | T2 | T3 |
|---|---|---|---|
| Standing temperature | 25° C. | 25° C. | 16° C. |
| UV irradiation temperature | 35° C. | 22° C. | 22° C. |

A sheet of white copy paper (the regions indicated by (1)) was used as the rear plate, and a coating material having conditions indicated in Table 3 below was applied to the hatched regions (2) in FIG. 1. Here, the condition B1 indicates there was no coating material applied, and the sheet of white copy paper was left as was (1). The condition B4 indicates absence, in other words, the presence of air, and nothing was present 30 cm below (2) (simulating the vacuum chuck).

TABLE 3

| Reflector plate conditions | B1 | B2 | B3 | B4 |
|---|---|---|---|---|
| Reflectance of (2) portions assuming | 100% | 70% | 40% | 0% |
| reflectance of (1) portions a s 100 | | | | |

Abbreviations of the properties of the liquid crystal compositions and the polymer dispersed liquid crystal compositions described in Examples and the meaning thereof are as follows.

Tni(LC): nematic phase-isotropic liquid phase transition temperature (° C.) of liquid crystal composition

Δn: refraction index anisotropy of the liquid crystal composition at 25° C.

Tni(PNM): nematic phase-isotropic liquid phase transition temperature (° C.) of polymer dispersed liquid crystal composition

T0: transmittance (%) of the polymer dispersed liquid crystal element with voltage OFF when the light quantity under the absence (air) condition is assumed to be 100% and when the cell thickness is 10 μm and the temperature is 25° C.

T100: transmittance (%) of the polymer dispersed liquid crystal element under application of 50 V voltage when the light quantity under the absence (air) condition is assumed to be 100% and when the cell thickness is 10 μm and the temperature is 25° C.

V90: applied voltage value (V) at a light transmittance of 90% by assuming that the light transmittance (T0) of the polymer dispersed liquid crystal element in the absence of applied voltage is 0% and the light transmittance (T100) under application of 50 V voltage is 100% when the cell thickness is 10 μm and the temperature is 25° C.

The evaluation methods were follows.

The transition point was measured with a temperature control system FP-90 and a hot stage FP82 produced by Mettler Toledo.

T0, T100, and V90 were measured with an LCD evaluation system LCD-5200 produced by OTSUKA ELECTRONICS CO., LTD., with B lens and aperture S. The measurement was conducted on 100 points in respective squares of one cell as illustrated in FIG. 2.

From the evaluations values of T0 described above, the average value (A) of the top 10% transmittances and the average value (B) of the bottom 10% transmittances within the surface were calculated, and the value of (A−B)/B×100 was evaluated as the degree of inhomogeneity.

In addition, whether the difference in transmittance within the surface of the cell can be identified by naked eye was also evaluated. The standard is indicated in Table 4.

TABLE 4

| Naked | |
|---|---|
| eye | |
| evaluation | Evaluation standard |
| M1 | Difference is unidentifiable. |
| M2 | Difference is vaguely identifiable depending on |
| | optical conditions but is substantially unidentifiable. |
| M3 | Difference is very slight and is not noticeable. |
| M4 | Slight difference is observed. |
| M5 | Difference is clearly observed. |

The refraction index was measured with an Abbe's refractometer (produced by ATAGO CO., LTD.).

The reflectance at 365 nm was measured with UV-Vis-IR Spectrophotometer U-4100 produced by Hitachi Ltd.

The ultraviolet intensity was measured with UIT-250 produced by Ushio Inc., using sensors for 365 nm and 313 nm.

Following compositions were used as the liquid crystal compositions.

(Liquid crystal composition LC1) Δn=0.226, Tni(LC)=87.4° C.

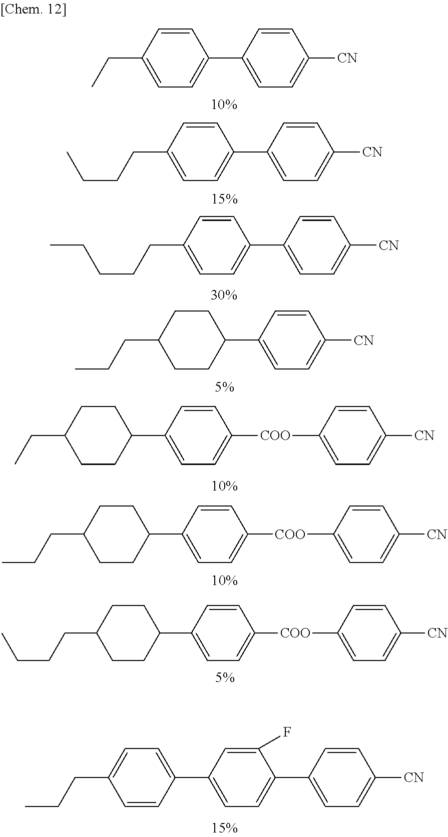

(Liquid crystal composition LC2) Δn=0.218, Tni(LC)=73.9° C.

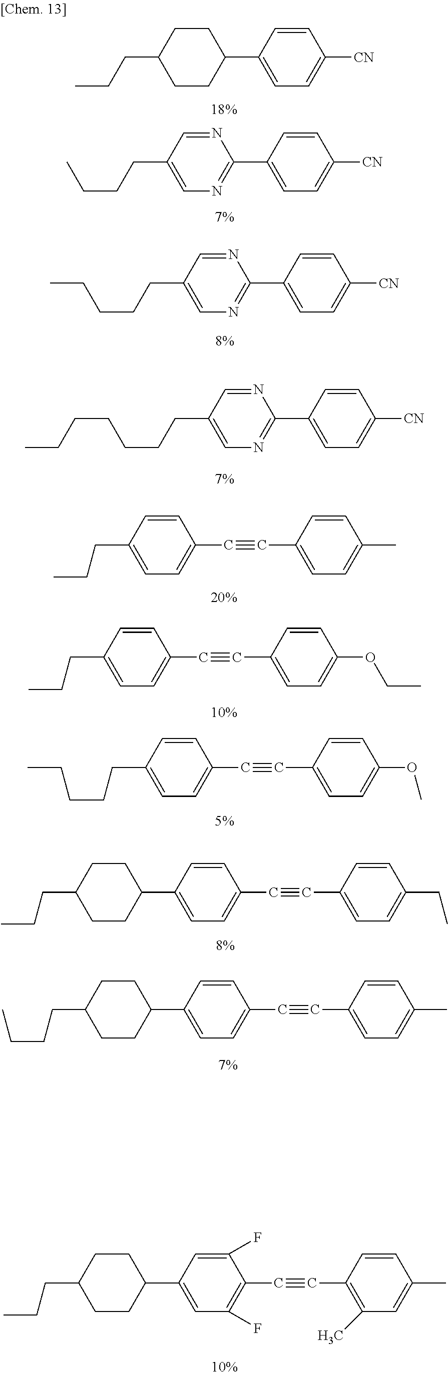

(Liquid crystal composition LC3) Δn=0.219, Tni(LC)=83.8° C.

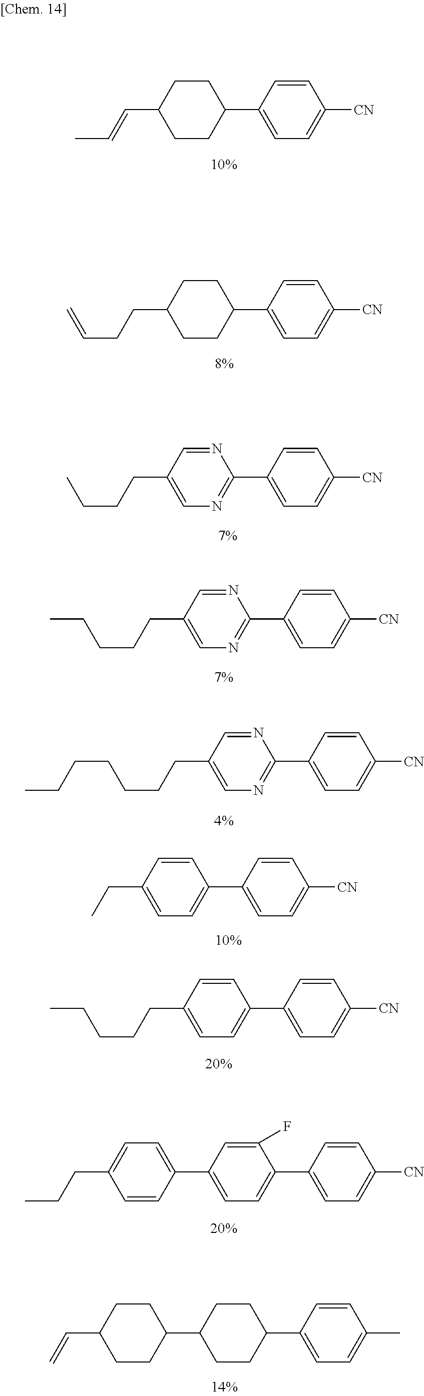

(Liquid crystal composition LC4) Δn=0.226, Tni(LC)=73.8° C.

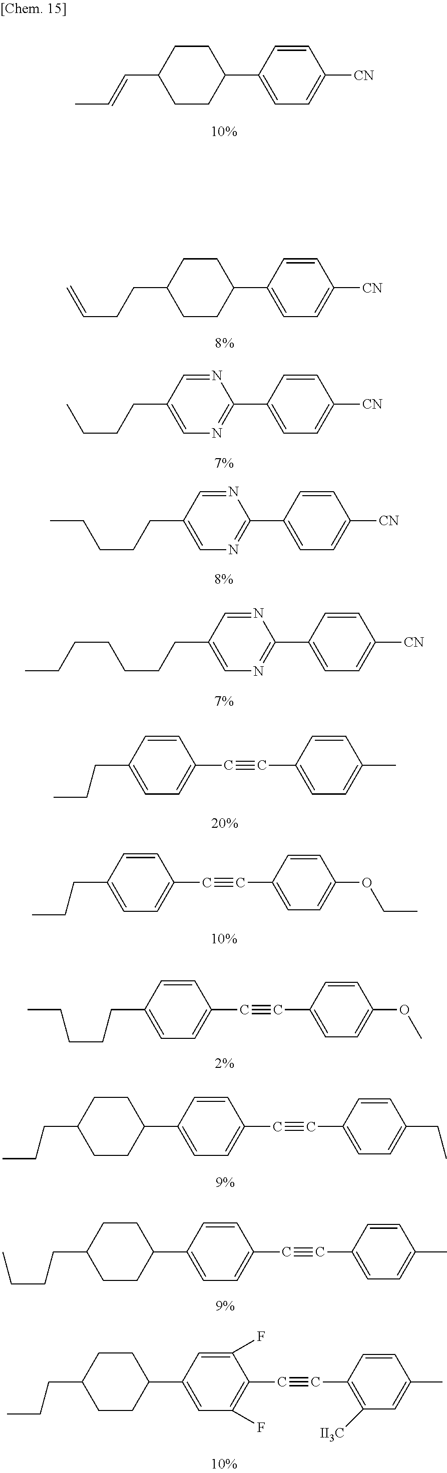

A composition containing the following compound was used as the monomer composition.

### (Monomer Composition a)

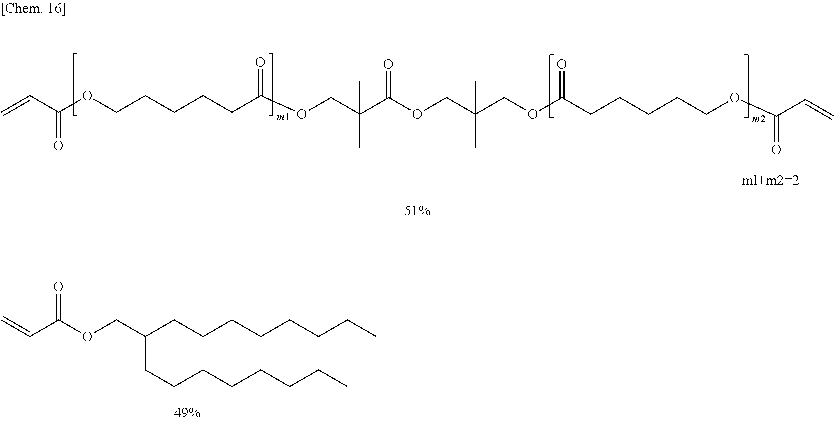

The following compound was used as the photoinitiator.

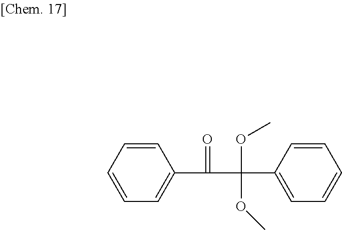 [SMILES: COC(OC)(C(=O)c1ccccc1)c1ccccc1]

### Examples 1 to 12 and Comparative Examples 1 to 6

Tables 5 to 9 show conditions and evaluation results of Examples and Comparative Examples 1 to 6. In the tables, Max Ave. indicates the average value of the top 10% transmittances T0 within the surface and the average values of T100 and V90 at that point, and Min Ave. indicates the average value of the bottom 10% transmittances T0 within the surface and the average values of T100 and V90 at that point. Average Value indicates the average value of the entirety.

TABLE 5

| Examples | Example 1 | | | Example 2 | | | Example 3 | | | Example 4 | | |
|---|---|---|---|---|---|---|---|---|---|---|---|---|
| Liquid crystal | LC4 | | | LC1 | | | LC2 | | | LC3 | | |
| composition | | | | | | | | | | | | |
| Tni(PNM) | 19.2 | | | 20.1 | | | 19.5 | | | 19.8 | | |
| Filter conditions | F3 | | | F3 | | | F3 | | | F3 | | |
| Temperature | T2 | | | T2 | | | T2 | | | T2 | | |
| conditions | | | | | | | | | | | | |
| Reflector plate | B1 | | | B1 | | | B1 | | | B1 | | |
| conditions | | | | | | | | | | | | |
| Naked eye | M1 | | | M1 | | | M1 | | | M1 | | |
| evaluation | | | | | | | | | | | | |
| Measurement site | T0 | T100 | V90 | T0 | T100 | V90 | T0 | T100 | V90 | T0 | T100 | V90 |
| Max Ave. | 0.36 | 87.2 | 3.3 | 1.88 | 87.4 | 24.0 | 0.51 | 87.2 | 5.5 | 0.72 | 87.2 | 12.7 |
| Min Ave. | 0.32 | 86.1 | 3.1 | 1.74 | 86.3 | 23.6 | 0.42 | 85.8 | 5.3 | 0.62 | 86.1 | 12.5 |
| Average Value | 0.33 | 86.6 | 3.2 | 1.82 | 86.7 | 23.8 | 0.45 | 86.3 | 5.4 | 0.66 | 86.7 | 12.6 |

| | | | | |
|---|---|---|---|---|
| Degree of | 12.5 | 8.0 | 21.4 | 16.1 |
| inhomogeneity | | | | |

TABLE 6

| Examples | Example 5 | | | Comparative Example 1 | | | Comparative Example 2 | | | Example 6 | | |
|---|---|---|---|---|---|---|---|---|---|---|---|---|
| Liquid crystal | LC4 | | | LC4 | | | LC4 | | | LC1 | | |
| composition | | | | | | | | | | | | |
| Tni(PNM) | 19.2 | | | 19.2 | | | 19.2 | | | 20.1 | | |
| Filter conditions | F3 | | | F3 | | | F3 | | | F3 | | |
| Temperature | T2 | | | T2 | | | T2 | | | T2 | | |
| conditions | | | | | | | | | | | | |
| Reflector plate | B2 | | | B3 | | | B4 | | | B2 | | |
| conditions | | | | | | | | | | | | |
| Naked eye | M2 | | | M4 | | | M5 | | | M1 | | |
| evaluation | | | | | | | | | | | | |
| Measurement site | T0 | T100 | V90 | T0 | T100 | V90 | T0 | T100 | V90 | T0 | T100 | V90 |
| Max Ave. | 0.78 | 87.1 | 3.2 | 6.08 | 87.3 | 3.3 | 11.28 | 87.4 | 3.3 | 2.43 | 86.9 | 24.2 |
| Min Ave. | 0.32 | 86.1 | 2.8 | 0.34 | 85.8 | 2.1 | 0.34 | 85.8 | 1.6 | 1.74 | 85.8 | 23.5 |
| Average Value | 0.51 | 86.5 | 3.1 | 1.79 | 86.5 | 2.9 | 3.74 | 86.6 | 2.7 | 1.94 | 86.4 | 23.9 |

| | | | | |
|---|---|---|---|---|
| Degree of | 143.8 | 1688.2 | 3217.6 | 39.7 |
| inhomogeneity | | | | |

TABLE 7

| Examples | Comparative Example 3 | | | Comparative Example 4 | | | Example 7 | | | Comparative Example 5 | | |
|---|---|---|---|---|---|---|---|---|---|---|---|---|
| Liquid crystal | LC1 | | | LC1 | | | LC2 | | | LC2 | | |
| composition | | | | | | | | | | | | |
| Tni(PNM) | 20.1 | | | 20.1 | | | 19.5 | | | 19.5 | | |
| Filter conditions | F3 | | | F3 | | | F3 | | | F3 | | |
| Temperature | T2 | | | T2 | | | T2 | | | T2 | | |
| conditions | | | | | | | | | | | | |
| Reflector plate | B3 | | | B4 | | | B2 | | | B3 | | |
| conditions | | | | | | | | | | | | |
| Naked eye | M2 | | | M3 | | | M2 | | | M3 | | |
| evaluation | | | | | | | | | | | | |
| Measurement site | T0 | T100 | V90 | T0 | T100 | V90 | T0 | T100 | V90 | T0 | T100 | V90 |
| Max Ave. | 5.54 | 87.1 | 24.1 | 9.86 | 87.3 | 24.1 | 0.73 | 87.1 | 5.4 | 2.14 | 87.3 | 5.4 |
| Min Ave. | 1.64 | 85.4 | 19.8 | 1.73 | 85.4 | 14.5 | 0.33 | 85.8 | 5.0 | 0.33 | 85.5 | 4.1 |
| Average Value | 2.60 | 86.3 | 22.8 | 4.22 | 86.4 | 21.4 | 0.47 | 86.5 | 5.3 | 0.90 | 86.3 | 5.0 |

| | | | | |
|---|---|---|---|---|
| Degree of | 237.8 | 469.9 | 121.2 | 548.5 |
| inhomogeneity | | | | |

TABLE 8

| Examples | Comparative Example 6 | | | Example 8 | | | Example 9 | | | Example 10 | | |
|---|---|---|---|---|---|---|---|---|---|---|---|---|
| Liquid crystal | LC2 | | | LC4 | | | LC4 | | | LC4 | | |
| composition | | | | | | | | | | | | |
| Tni(PNM) | 19.5 | | | 19.2 | | | 19.2 | | | 19.2 | | |
| Filter conditions | F3 | | | F3 | | | F3 | | | F3 | | |
| Temperature | T2 | | | T1 | | | T3 | | | T2 | | |
| conditions | | | | | | | | | | | | |
| Reflector plate | B4 | | | B1 | | | B1 | | | B1 | | |
| conditions | | | | | | | | | | | | |
| Naked eye | M4 | | | M1 | | | M2 | | | M1 | | |
| evaluation | | | | | | | | | | | | |
| Measurement site | T0 | T100 | V90 | T0 | T100 | V90 | T0 | T100 | V90 | T0 | T100 | V90 |
| Max Ave. | 4.23 | 87.4 | 5.4 | 0.85 | 87.1 | 4.1 | 0.78 | 87.1 | 3.6 | 0.42 | 87.1 | 3.2 |
| Min Ave. | 0.32 | 85.8 | 3.7 | 0.68 | 86.3 | 4.0 | 0.34 | 85.9 | 3.1 | 0.31 | 86.2 | 3.1 |
| Average Value | 1.57 | 86.5 | 4.8 | 0.77 | 86.7 | 4.1 | 0.52 | 86.5 | 3.3 | 0.36 | 86.8 | 3.2 |

| | | | | |
|---|---|---|---|---|
| Degree of | 1221.9 | 25.0 | 129.4 | 35.5 |
| inhomogeneity | | | | |

TABLE 9

| Examples | Example 11 | | | Example 12 | | |
|---|---|---|---|---|---|---|
| Liquid crystal composition | LC4 | | | LC4 | | |
| Tni(PNM) | 19.2 | | | 19.2 | | |
| Filter conditions | F2 | | | F1 | | |
| Temperature conditions | T2 | | | T2 | | |
| Reflector plate conditions | B1 | | | B1 | | |
| Naked eye evaluation | M1 | | | M1 | | |
| Measurement site | T0 | T100 | V90 | T0 | T100 | V90 |
| Max Ave. | 0.98 | 82.5 | 5.7 | 1.93 | 78.9 | 8.0 |
| Min Ave. | 0.68 | 80.8 | 5.1 | 1.22 | 74.5 | 7.6 |
| Average Value | 0.80 | 81.8 | 5.4 | 1.54 | 77.1 | 7.8 |

| | | |
|---|---|---|
| Degree of inhomogeneity | 44.1 | 58.2 |

It can be understood from the results of Examples and Comparative Examples that the appearance of the display element differs depending on the reflection conditions of the panel rear surface, and that the difference varies depending on the liquid crystal composition. By employing a method for manufacturing a polymer dispersed liquid crystal display element of the present invention, a novel polymer dispersed liquid crystal display element having homogeneous properties with which inhomogeneity is unrecognizable or unidentifiable with naked eye during the absence of voltage application could be prepared.

1. A method for manufacturing a polymer dispersed liquid crystal display element that has a light control layer that contains a liquid crystal material and a polymer substance and that is obtained by interposing a light control layer-forming material containing a liquid crystal material and a polymerizable composition between two substrates at least one of which has an electrode layer and at least one of which is transparent, and then irradiating the light control layer-forming material with ultraviolet light to polymerize the polymerizable composition, wherein, in a transmittance distribution of the light control layer, a ratio ((A−B)/B×100) of a difference (A−B) between an average value A of the top 10% and an average value B of the bottom 10% to the average value B of the bottom 10% is 200% or less,
the liquid crystal material contains one or more compounds represented by general formula (I): 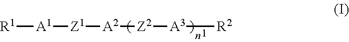
In the formula, le represents an alkyl group having 1 to 10 carbon atoms, one or two nonadjacent CH₂ groups in the alkyl group may each be substituted with an oxygen atom, —COO—, or —OCO—, and at least one methylene group may be substituted with —CH═CH— or —CH≡CH—;
R² represents a fluorine atom, a chlorine atom, a cyano group, a CF₃ group, an OCF₃ group, an OCHF₂ group, a NCS group, or an alkyl group having 1 to 10 carbon atoms, one or two nonadjacent CH₂ groups in the alkyl group may each be substituted with an oxygen atom, —COO—, or —OCO—, at least one methylene group may be substituted with —CH═CH— or —C≡C,
Z¹ and Z² each independently represent a single bond, —COO—, —OCO—, —CH₂—CH₂, —CH═CH—, —CF₂O—, —OCF₂—, or —C≡C—, and when more than one Z¹ are present, they may be the same or different;
A¹, A², and A³ each independently represent a 1,4-phenylene group, a 1,4-cyclohexylene group, a 1,4-cyclohexenyl group, a tetrahydropyran-2,5-diyl group, a 1,3-dioxane-2,5-diyl group, a decahydronaphthalene-2,6-diyl group, a pyridine-2,5-diyl group, a pyrimidine-2,5-diyl group, a pyrazine-2,5-diyl group, a 1,2,3,4-tetrahydronaphthalene-2,6-diyl group, or a 2,6-naphthylene group, the 1,4-phenylene group, the 1,2,3,4-tetrahydrohaphthalene-2,6-diyl group, and the 2,6-naphthylene group may each be unsubstituted or have, as a substituent, one or more fluorine atoms, chlorine atoms, CF₃ groups, OCF₃ groups, or CH₃ groups, and when more than one A³ are present, they may be the same or different; and
n¹ represents 0, 1, or 2), and,
a minimum ultraviolet reflectance of an installation surface of the liquid crystal display element is 50% or more of a maximum ultraviolet reflectance, the installation surface being located on a side opposite of an ultraviolet irradiation lamp as viewed from the liquid crystal display element to be irradiated with the ultraviolet light.

2. The method for manufacturing a polymer dispersed liquid crystal display element according to claim 1, wherein the liquid crystal material contains one or more compounds represented by general formula (I-1): 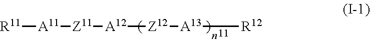
(In the formula, R¹¹ represents an alkyl group having 1 to 10 carbon atoms, one or two nonadjacent CH₂ groups in the alkyl group may each be substituted with an oxygen atom, —COO—, or —OCO—, and at least one methylene group may be substituted with —CH═CH— or —CH≡CH—;
R¹² represents a fluorine atom, a chlorine atom, a cyano group, a CF₃ group, an OCF₃ group, an OCHF₂ group, a NCS group, or an alkyl group having 1 to 10 carbon atoms, one or two nonadjacent CH₂ groups in the alkyl group may each be substituted with an oxygen atom, —COO—, or —OCO—, and at least one methylene group may be substituted with —CH═CH— or —C≡C—;
Z¹¹ and Z¹² each independently represent a single bond, —COO—, —OCO—, —CH₂—CH₂—, —CH═CH—, —CF₂O—, —OCF₂—, or —C≡C—, and when more than one Z¹² are present, they may be the same or different;
A¹¹, A¹², A¹³ each independently represent a 1,4-phenylene group, a 1,4-cyclohexylene group, a 1,4-cyclohexenyl group, a tetrahydropyran-2,5-diyl group, a 1,3-dioxane-2,5-diyl group, a decahydronaphthalene-2,6-diyl group, a pyridine-2,5-diyl group, a pyrimidine-2,5-diyl group, a pyrazine-2,5-diyl group, a 1,2,3,4-tetrahydronaphthalene-2,6-diyl group, or a 2,6-naphthylene group, the 1,4-phenylene group, the 1,2,3,4-tetrahydrohaphthalene-2,6-diyl group, and the 2,6-naphthylene group may each be unsubstituted or have, as a substituent, one or more fluorine atoms, chlorine atoms, CF₃ groups, OCF₃ groups, or CH₃ groups, and when more than one A¹³ are present, they may be the same or different;
n¹¹ represents 0, 1, or 2; and
at least one methylene group in R¹¹ is substituted with —CH═CH— or at least one methylene group in R¹² is substituted with —CH═CH— or Z¹¹ represents —CH═CH— or and/or Z¹² when present is —CH═CH— or —C≡C—.)

3. The method for manufacturing a polymer dispersed liquid crystal display element according to claim 1, wherein
the polymerizable composition described in claim 1, contains general formula (IV-1) 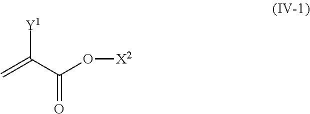
(In the formula, Y¹ represents a hydrogen atom or a methyl group, X² represents an alkyl group that has 8 to 30 carbon atoms and may have a branched or cyclic group (one or two or more nonadjacent —CH₂— in the alkyl group may each independently be substituted with an oxygen atom, —COO—, or —OCO—).

4. The method for manufacturing a polymer dispersed liquid crystal display element according to claim 1, wherein, after the light control layer-forming material is interposed between the two substrates and until ultraviolet irradiation is performed, the light control layer-forming material is maintained at a temperature equal to or higher than a nematic-isotropic transition point of the light control layer-forming material, and during ultraviolet irradiation, the temperature is controlled to be equal to or higher than the nematic-isotropic transition point.

5. The method for manufacturing a polymer dispersed liquid crystal display element according to claim 1, to wherein ultraviolet light in which an intensity of 313 nm ultraviolet light is 10% or less of an intensity of 365 nm ultraviolet light is applied.

6. A polymer dispersed liquid crystal display element comprising two substrates at least one of which has an electrode layer and at least one of which is transparent, and a light control layer that is disposed between the two substrates and that contains a liquid crystal material and a polymer substance obtained by polymerizing a polymerizable composition, wherein, in a transmittance distribution of the light control layer, a ratio ((A−B)/B×100) of a difference (A−B) between an average value A of the top 10% and an average value B of the bottom 10% to the average value B of the bottom 10% is 200% or less,
the liquid crystal material contains one or more compounds represented by general formula (I): 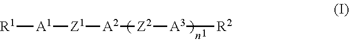
(In the formula, R¹ represents an alkyl group having 1 to 10 carbon atoms, one or two nonadjacent CH₂ groups in the alkyl group may each be substituted with an oxygen atom, —COO—, or —OCO—, and at least one methylene group may be substituted with —CH═CH— or R² represents a fluorine atom, a chlorine atom, a cyano group, a CF₃ group, an OCF₃ group, an OCHF₂ group, a NCS group, or an alkyl group having 1 to 10 carbon atoms, one or two nonadjacent CH₂ groups in the alkyl group may each be substituted with an oxygen atom, —COO—, or —OCO—, at least one methylene group may be substituted with —CH═CH— or —C≡C—, and R² preferably represents a fluorine atom, a cyano group, or an alkyl group having 1 to 5 carbon atoms (one or two nonadjacent CH₂ groups in the alkyl group may each be substituted with an oxygen atom, and at least one methylene group may be substituted with —CH═CH— or —CH≡CH—),
Z¹ and Z² each independently represent a single bond, —COO—, —OCO—, —CH₂—CH₂, —CH═CH—, —CF₂O—, —OCF₂—, or —C≡C—, and when more than one Z¹ are present, they may be the same or different;
A¹, A², and A³ each independently represent a 1,4-phenylene group, a 1,4-cyclohexylene group, a 1,4-cyclohexenyl group, a tetrahydropyran-2,5-diyl group, a 1,3-dioxane-2,5-diyl group, a decahydronaphthalene-2,6-diyl group, a pyridine-2,5-diyl group, a pyrimidine-2,5-diyl group, a pyrazine-2,5-diyl group, a 1,2,3,4-tetrahydronaphthalene-2,6-diyl group, or a 2,6-naphthylene group, the 1,4-phenylene group, the 1,2,3,4-tetrahydrohaphthalene-2,6-diyl group, and the 2,6-naphthylene group may each be unsubstituted or have, as a substituent, one or more fluorine atoms, chlorine atoms, CF₃ groups, OCF₃ groups, or CH₃ groups, and when more than one A³ are present, they may be the same or different, and
n¹ represents 0, 1, or 2.)

7. The polymer dispersed liquid crystal display element according to claim 6, wherein the liquid crystal material contains one or more compounds represented by general formula (I-1): 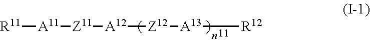
(In the formula, R¹¹ represents an alkyl group having 1 to 10 carbon atoms, one or two nonadjacent CH₂ groups in the alkyl group may each be substituted with an oxygen atom, —COO—, or —OCO—, and at least one methylene group may be substituted with —CH═CH— or —CH≡CH—;
R¹² represents a fluorine atom, a chlorine atom, a cyano group, a CF₃ group, an OCF₃ group, an OCHF₂ group, a NCS group, or an alkyl group having 1 to 10 carbon atoms, one or two nonadjacent CH₂ groups in the alkyl group may each be substituted with an oxygen atom, —COO—, or —OCO—, and at least one methylene group may be substituted with —CH═CH— or —C≡C—;
Z¹¹ and Z¹² each independently represent a single bond, —COO—, —CH₂—CH₂—, —CH═CH—, —CF₂O—, —OCF₂—, or —C≡C—, and when more than one Z¹² are present, they may be the same or different;
A¹¹, A¹², and A¹³ each independently represent a 1,4-phenylene group, a 1,4-cyclohexylene group, a 1,4-cyclohexenyl group, a tetrahydropyran-2,5-diyl group, a 1,3-dioxane-2,5-diyl group, a decahydronaphthalene-2,6-diyl group, a pyridine-2,5-diyl group, a pyrimidine-2,5-diyl group, a pyrazine-2,5-diyl group, a 1,2,3,4-tetrahydronaphthalene-2,6-diyl group, or a 2,6-naphthylene group, the 1,4-phenylene group, the 1,2,3,4-tetrahydrohaphthalene-2,6-diyl group, and the 2,6-naphthylene group may each be unsubstituted or have, as a substituent, one or more fluorine atoms, chlorine atoms, CF₃ groups, OCF₃ groups, or CH₃ groups, and when more than one A¹³ are present, they may be the same or different;
n¹¹ represents 0, 1, or 2; and
at least one methylene group in R¹¹ is substituted with —CH═CH— or at least one methylene group in R¹² is substituted with —CH═CH— or represents —CH═CH— or and/or Z¹² when present is —CH═CH— or —C≡C—.)

8. The polymer dispersed liquid crystal display element according to claim 6, wherein
the polymerizable composition contains general formula (IV-1) 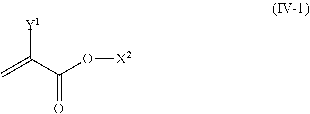
(In the formula, Y¹ represents a hydrogen atom or a methyl group, X² represents an alkyl group that has 8 to 30 carbon atoms and may have a branched or cyclic group (one or two or more nonadjacent —CH₂— in the alkyl group may each independently be substituted with an oxygen atom, —COO—, or —OCO—).
